(19) United States
(12) Patent Application Publication
(10) Pub. No.: US 2017/0045419 A1
(43) Pub. Date: Feb. 16, 2017

(54) SYSTEM AND METHOD FOR STEP TEST-FREE MACHINE MODELING USING STATISTICAL INFORMATION ABOUT MULTIPLE WEB MANUFACTURING OR PROCESSING SYSTEMS

(71) Applicant: Honeywell International Inc., Morristown, NJ (US)

(72) Inventors: Gregory E. Stewart, North Vancouver (CA); David J. Germann, North Vancouver (CA)

(21) Appl. No.: 14/822,767

(22) Filed: Aug. 10, 2015

(51) Int. Cl. G01M 99/00

(52) U.S. Cl. CPC G01M 99/005

(57) ABSTRACT

A method includes obtaining at least one statistical model identified using data associated with multiple web manufacturing or processing systems, where the data includes process models used to control the multiple web manufacturing or processing systems. The method also includes obtaining one or more machine specifications of a particular web manufacturing or processing system. The method further includes generating at least one estimated process model for the particular web manufacturing or processing system using the statistical model(s) and the machine specification(s). The estimated process model(s) can be generated without step testing of the particular web manufacturing or processing system. The statistical model(s) could be generated by performing a statistical regression for each of multiple actuator-measurement pairs, where each actuator-measurement pair is associated with a particular type of actuator and a particular type of sensor measurement or inferred property in the multiple web manufacturing or processing systems.

### TECHNICAL FIELD

This disclosure relates generally to web manufacturing or processing systems. More specifically, this disclosure relates to a system and method for step test-free machine modeling using statistical information about multiple web manufacturing or processing systems.

### BACKGROUND

Sheets or other webs of material are used in a variety of industries and in a variety of ways. These materials can include paper, multi-layer paperboard, and other products manufactured or processed in long webs. As a particular example, long sheets of paper can be manufactured and collected in reels.

It is often necessary or desirable to measure one or more properties of a web of material as the web is being manufactured or processed. Adjustments can then be made to the manufacturing or processing system to ensure that the properties stay within desired ranges. Model-based industrial process controllers are routinely used to control the operation of a web manufacturing or processing system, and one or more models can be used to mathematically represent how one or more properties of a web respond to changes made to the system (such as changes made to actuators in the system). These models are often created during “step testing” (also known as “bump testing”), where changes like actuator steps are intentionally created in the system so that the effects of those changes on the properties of a web can be identified.

### SUMMARY

This disclosure provides a system and method for step test-free machine modeling using statistical information about multiple web manufacturing or processing systems.

In a first embodiment, a method includes obtaining at least one statistical model identified using data associated with multiple web manufacturing or processing systems, where the data includes process models used to control the multiple web manufacturing or processing systems. The method also includes obtaining one or more machine specifications of a particular web manufacturing or processing system. In addition, the method includes generating at least one estimated process model for the particular web manufacturing or processing system using the at least one statistical model and the one or more machine specifications.

In a second embodiment, an apparatus includes at least one memory configured to store at least one statistical model identified using data associated with multiple web manufacturing or processing systems, where the data includes process models used to control the multiple web manufacturing or processing systems. The apparatus also includes at least one processing device configured to obtain one or more machine specifications of a particular web manufacturing or processing system and generate at least one estimated process model for the particular web manufacturing or processing system using the at least one statistical model and the one or more machine specifications.

In a third embodiment, a non-transitory computer readable medium contains instructions that when executed cause at least one processing device to obtain at least one statistical model identified using data associated with multiple web manufacturing or processing systems, where the data includes process models used to control the multiple web manufacturing or processing systems. The non-transitory computer readable medium also contains instructions that when executed cause the at least one processing device to obtain one or more machine specifications of a particular web manufacturing or processing system. In addition, the non-transitory computer readable medium contains instructions that when executed cause the at least one processing device to generate at least one estimated process model for the particular web manufacturing or processing system using the at least one statistical model and the one or more machine specifications.

In a fourth embodiment, a method includes obtaining data associated with multiple web manufacturing or processing systems. The data includes machine specifications of the multiple web manufacturing or processing systems and process models used to control the multiple web manufacturing or processing systems. The method also includes generating at least one statistical model using the data. The method further includes providing the at least one statistical model in order to generate at least one estimated process model for a particular web manufacturing or processing system using the at least one statistical model and one or more machine specifications of the particular web manufacturing or processing system.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example web manufacturing or processing system according to this disclosure;

FIG. 2 illustrates an example system for step test-free web machine modeling using statistical information about multiple web manufacturing or processing systems according to this disclosure;

FIG. 3 illustrates an example device supporting step test-free web machine modeling using statistical information about multiple web manufacturing or processing systems according to this disclosure; and

FIGS. 4 and 5 illustrate example methods for step test-free machine modeling using statistical information about multiple web manufacturing or processing systems according to this disclosure.

### DETAILED DESCRIPTION

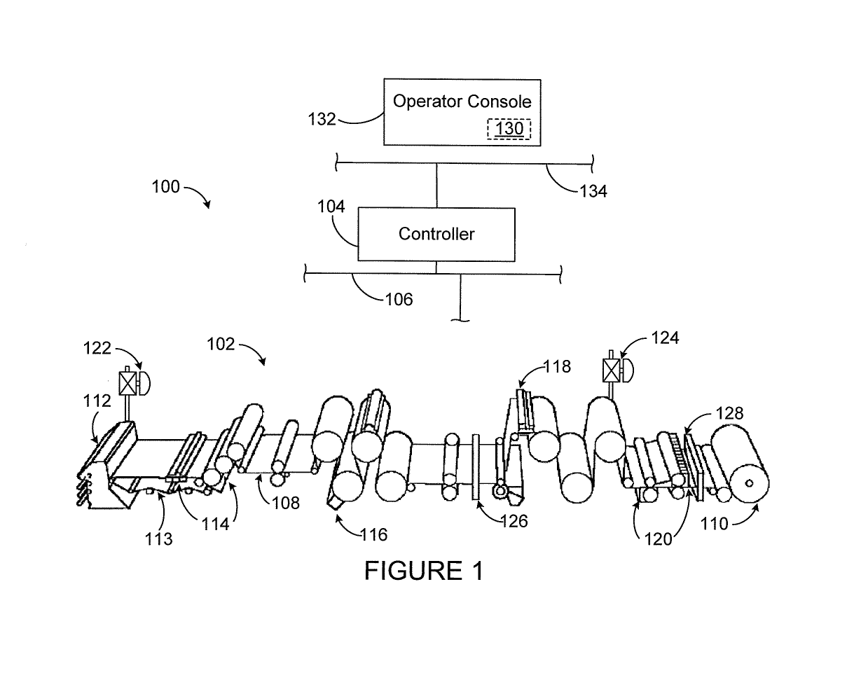

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example web manufacturing or processing system 100 according to this disclosure. As shown in FIG. 1, the system 100 includes a paper machine 102, a controller 104, and a network 106. The paper machine 102 includes various components used to produce a paper product, namely a paper web 108 that is collected at a reel 110. The controller 104 monitors and controls the operation of the paper machine 102, which may help to maintain or increase the quality of the paper web 108 produced by the paper machine 102. In the following description, the machine direction (MD) of the web 108 denotes the direction along the (longer) length of the web 108, while the cross direction (CD) of the web 108 denotes the direction along the (shorter) width of the web 108.

In this example, the paper machine 102 includes at least one headbox 112, which distributes a pulp suspension uniformly across the machine onto a continuous moving wire screen or mesh 113. The pulp suspension entering the headbox 112 may contain, for example, 0.2-3% wood fibers, fillers, and/or other materials, with the remainder of the suspension being water. The headbox 112 may include an array of dilution actuators, which distributes dilution water into the pulp suspension across the web. The headbox 112 may also include an array of slice lip actuators, which controls a slice opening across the machine from which the pulp suspension exits the headbox 112 onto the moving wire screen or mesh 113.

Arrays of drainage elements 114, such as vacuum boxes, remove as much water as possible to initiate the formation of the web 108. An array of steam actuators 116 produces hot steam that penetrates the paper web 108 and releases the latent heat of the steam into the paper web 108. An array of rewet shower actuators 118 adds small droplets of water (which may be air atomized) onto the surface of the paper web 108. The paper web 108 is then often passed through a calender having several nips of counter-rotating rolls. Arrays of induction heating actuators 120 heat the shell surfaces of various ones of these rolls.

Two additional actuators 122-124 are shown in FIG. 1. A thick stock flow actuator 122 controls the consistency of incoming stock received at the headbox 112. A steam flow actuator 124 controls the amount of heat transferred to the paper web 108 from drying cylinders. The actuators 122-124 could, for example, represent valves controlling the flow of stock and steam, respectively. These actuators may be used for controlling the dry weight, moisture, and caliper (thickness) of the paper web 108. Additional flow actuators may be used to control the proportions of different types of pulp and filler material in the thick stock and to control the amounts of various additives (such as retention aid or dyes) that are mixed into the stock.

This represents a brief description of one type of paper machine 102 that may be used to produce a paper product. Additional details regarding this type of paper machine 102 are well-known in the art and are not needed for an understanding of this disclosure.

In order to control the paper-making process, one or more properties of the paper web 108 may be continuously or repeatedly measured. The web properties can be measured at one or various stages in the manufacturing process. This information may then be used to adjust the paper machine 102, such as by adjusting various actuators within the paper machine 102. This may help to compensate for any variations of the web properties from desired targets, which may help to ensure the quality of the web 108.

As shown in FIG. 1, the paper machine 102 includes one or more scanners 126-128, each of which may include one or more sensors. Each scanner 126-128 is capable of measuring one or more characteristics of the paper web 108. For example, each scanner 126-128 could include sensors for measuring the tension, caliper, moisture, anisotropy, basis weight, color, gloss, sheen, haze, surface features (such as roughness, topography, or orientation distributions of surface features), or any other or additional characteristics of the paper web 108.

Each scanner 126-128 includes any suitable structure or structures for measuring or detecting one or more characteristics of the paper web 108, such as one or more sets of sensors. The use of scanners represents one particular embodiment for measuring web properties. Other embodiments could be used, such as those including one or more stationary sets or arrays of sensors, deployed in one or a few locations across the web or deployed in a plurality of locations across the whole width of the web such that substantially the entire web width is measured.

The controller 104 receives measurement data from the scanners 126-128 and uses the data to control the paper machine 102. For example, the controller 104 may use the measurement data to adjust any of the actuators or other components of the paper machine 102. The controller 104 includes any suitable structure for controlling the operation of at least part of the paper machine 102, such as a computing device. Note that while a single controller 104 is shown here, multiple controllers 104 could be used, such as different controllers that control different variables of the web.

The network 106 is coupled to the controller 104 and various components of the paper machine 102 (such as the actuators and scanners). The network 106 facilitates communication between components of the system 100. The network 106 represents any suitable network or combination of networks facilitating communication between components in the system 100. The network 106 could, for example, represent a wired or wireless Ethernet network, an electrical signal network (such as a HART or FOUNDATION FIELDBUS network), a pneumatic control signal network, or any other or additional network(s).

The controller(s) 104 can operate to control one or more aspects of the paper machine 102 using one or more models. For example, each model could associate one or more manipulated variables with one or more controlled variables. A controlled variable generally represents a variable that can be measured or inferred and that is ideally controlled to be at or near a desired setpoint or within a desired range of values. The controlled variables typically include one or more properties of the web 108. A manipulated variable generally represents a variable that can be adjusted in order to alter one or more controlled variables. The manipulated variables typically include setpoints or other values used by various actuators in the system 100.

As noted above, models for a web manufacturing or processing system are often created during “step testing,” where changes to the system are intentionally created so that the effects of those changes on one or more properties of a web can be identified. Data is collected during the step testing, such as sensor measurements of the one or more properties of the web 108, and the data is used by a model identification algorithm to generate a model. As a specific example, a CD model of a paper machine could be generated to identify how changes to an array of actuators affect a CD profile of the web. This model identification technique is a standard requirement for CD controller design and is often accomplished by placing a CD control loop into an open-loop mode and performing the step testing.

The web produced during step testing is often unusable, resulting in monetary and material losses. In addition, there are times when convenience is valued above model accuracy, such as when a web machine is not running stably (like during machine startup), during the installation of a new actuator array, or during periods of varying conditions (like when changes occur to machine speeds or web grades).

This disclosure recognizes that some manufacturers, vendors, or other entities have access to a large amount of data regarding controllers used in web manufacturing or processing systems. For example, an entity could collect thousands of controller models (such as model parameters) related to paper machines and other web manufacturing or processing systems over a number of years, where those systems include various types of actuators in various configurations. An entity could also collect other information related to paper machines and other web manufacturing or processing systems, such as data sets including operational data associated with step testing or other operations of the web manufacturing or processing systems. This data can be analyzed or “mined,” and one or more regression analyses can be performed across model parameters in order to generate one or more statistical models.

Machine specifications associated with a particular web manufacturing or processing system can be used as inputs to the one or more statistical models. The statistical model(s) can be operated using these inputs to generate one or more estimated process models for the web manufacturing or processing system. For example, the estimated process model(s) could represent an estimated CD response shape or other characteristic(s) of the web manufacturing or processing system. The estimated process model(s) can then be provided to a process controller, which uses the estimated process model(s) to provide some level of control over the particular web manufacturing or processing system. The estimated process model(s) can be delivered in any suitable manner, such as by using control system and tuning products and services.

To support this approach, the system 100 could provide a user with a tool 130 that allows the user to input a set of machine specifications for a paper machine 102 or other web manufacturing or processing system. The machine specifications could include the actuator type and actuator spacing of an actuator array in the system 100, the measurement type of sensors in the system 100, dimensions of the machine 102, a grade of the web 108, and a machine speed. The tool 130 can use these machine specifications along with the statistical model(s) described above to generate one or more estimated process models that represent the paper machine 102 or other web manufacturing or processing system. As an example, the estimated process model(s) could represent an estimated CD response shape and its associated uncertainty (error bars) or other characteristic(s) of the system. In this way, the user may configure one or more conservative control loops (such as a CD control loop) within the controller 104 and put the control loop(s) into a closed-loop mode of operation. A degree of gain scheduling may naturally be built into the estimated process model(s) due to each process model being a function of machine specifications such as machine speed.

In this way, a user is able to quickly and easily establish some form of closed-loop control over a web manufacturing or processing system without performing step testing. This can increase the speed at which the controller 104 can be brought online, and reduce monetary or material losses associated with step testing. While models generated in this manner may not be as accurate as models generated using step testing, the models can be accurate enough for use in certain circumstances. Those circumstances can include times such as when the system is not running stably (like during machine startup), during the installation of a new actuator array, or during periods of varying conditions (like when changes occur to machine speeds or web grades).

In some embodiments, at least one operator console 132 can communicate with the controller 104 over a network 134. The operator console 132 could support the tool 130 that receives machine specifications of the system and that generates or obtains one or more estimated process models based on those machine specifications. The operator console 132 generally represents a computing device and can include one or more processing devices, one or more memories, and one or more interfaces. Each processing device includes any suitable processing or computing device, such as a microprocessor, microcontroller, digital signal processor, field programmable gate array, application specific integrated circuit, or discrete logic devices. Each memory includes any suitable storage and retrieval device, such as a random access memory (RAM) or Flash or other read-only memory (ROM). Each interface includes any suitable structure facilitating communication over a connection or network, such as a wired interface (like an Ethernet interface) or a wireless interface (like a radio frequency transceiver). The network 134 represents any suitable network or combination of networks that can transport information, such as an Ethernet network.

Note that while the operator console 132 is described as implementing the tool 130 for generating an estimated process model, other types of devices could also be used. For instance, as described below, the operator console 132 could interact with a remote server, computing cloud, or other computing device or system, and the remote device or system could execute algorithms for analyzing data, identifying statistical models, and generating estimated process models using the statistical models. One or more estimated process models could then be provided to the operator console 132, such as via a network like the Internet.

Although FIG. 1 illustrates one example of a web manufacturing or processing system 100, various changes may be made to FIG. 1. For example, other systems could be used to produce other paper or non-paper products. Also, while shown as including a single paper machine 102 with various components and a single controller 104, the system 100 could include any number of paper machines or other machinery having any suitable structure, and the system 100 could include any number of controllers. In addition, FIG. 1 illustrates one example operational environment in which one or more estimated process models can be used. This functionality could be used in any other suitable system, regardless of whether that system is used to manufacture or process webs of material.

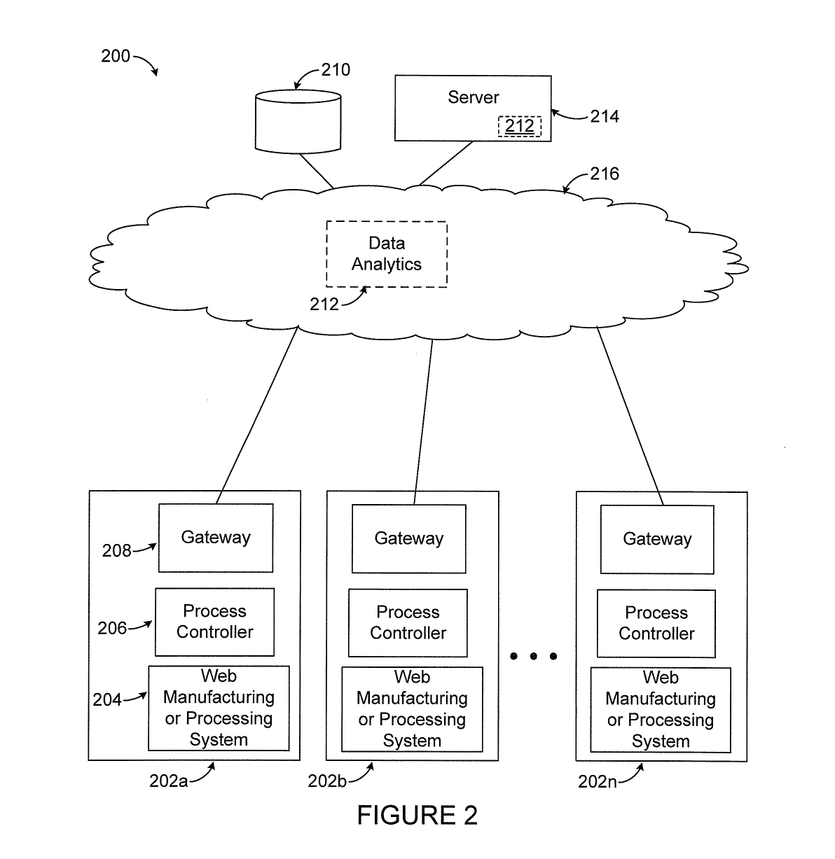

FIG. 2 illustrates an example system 200 for step test-free web machine modeling using statistical information about multiple web manufacturing or processing systems according to this disclosure. As shown in FIG. 2, the system 200 includes multiple sites 202a-202n. Each site 202a-202n generally denotes a location at which one or more web manufacturing or processing systems 204 are used. Different sites 202a-202n could denote facilities associated with a common entity and/or facilities associated with multiple entities. The web manufacturing or processing systems 204 at the different sites 202a-202n could represent systems identical or similar to the one shown in FIG. 1 and described above, although any other suitable systems for manufacturing or processing webs of material could be used.

Each web manufacturing or processing system 204 generally includes or is associated with one or more model-based process controllers 206, which are used to control the associated system 204. Each of the process controllers 206 could represent the controller 104 from FIG. 1. Each site 202a-202n could further include at least one gateway 206. Each gateway 206 allows data transfers to or from a site 202a-202n. For example, the gateways 206 may allow process models (such as model parameters) or data sets (such as operational data associated with step testing) to be uploaded from the sites 202a-202n to a remote computing device or system. The gateways 206 may also allow estimated process models, statistical models, or other information to be received from the remote computing device or system. Each gateway 206 includes any suitable structure supporting communication with an industrial site.

As described above, data associated with a large number of web manufacturing or processing systems 204 could be collected and stored in one or more databases 210. The collection of this data could occur in any suitable manner. For example, the various sites 202a-202n could be queried for or upload this data, or the data could be collected and provided manually or in an automated manner as controllers are installed and commissioned at the sites 202a-202n.

The collected data is analyzed using data analytics 212 in order to identify statistical properties of the process models or data sets associated with the web manufacturing or processing systems 204. These statistical properties could then be used to generate one or more estimated process models for a particular web manufacturing or processing system based on one or more machine specifications of that web manufacturing or processing system. If and when step testing later occurs for the particular web manufacturing or processing system, the actual process models or data collected during step testing could be stored in the database 210 and provided to the data analytics 212. This improves the richness of the data stored in the database 210, and it allows the analytics 212 to use the updated information to improve the accuracy of subsequent statistical regressions.

The data analytics 212 could be provided in any suitable manner. For example, in some embodiments, the data analytics 212 could be executed by a server 214 or other computing device. The server 214 could include one or more processing devices, one or more memories, and one or more interfaces. Each processing device includes any suitable processing or computing device, such as a microprocessor, microcontroller, digital signal processor, field programmable gate array, application specific integrated circuit, or discrete logic devices. Each memory includes any suitable storage and retrieval device, such as a RAM or Flash or other ROM. Each interface includes any suitable structure facilitating communication over a connection or network, such as a wired interface (like an Ethernet interface) or a wireless interface (like a radio frequency transceiver).

In other embodiments, the data analytics 212 could be executed within a network-based environment 216, such as a computing cloud. The network-based environment 216 could include various components that support network-based analysis of web manufacturing or processing systems. For example, the network-based environment 216 could include servers or other computing devices executing logic that analyzes data associated with the web manufacturing or processing systems 204, as well as database servers or other computing devices for storing data used by the logic.

Any suitable analysis could occur as part of the data analytics 212 in order to identify one or more statistical models associated with the collected data. As an example, a statistical regression can be performed for each of one or more actuator-measurement pairs associated with web manufacturing or processing systems. Each actuator-measurement pair is related to a specific type of actuator (or collection of actuators) and a specific type of sensor measurement or inferred property (or collection of sensor measurements or inferred properties). As particular examples, the actuator type could be one of the dilution actuators or the slice lip actuators in the headbox 112, the steam actuators 116, rewet shower actuators 118, induction heating actuators 120, thick stock flow actuator 122, or steam flow actuator 124. The sensor measurement or inferred property type could be one of tension, caliper, moisture, anisotropy, basis weight, color, gloss, sheen, haze, or surface feature. Effectively, each statistical regression describes a relationship between changes made to one of the actuator types and the corresponding changes to one of the sensor measurement or inferred property types.

In some embodiments, each statistical regression is used to generate a statistical model f, which associates machine specifications X and regression parameters θ with estimated process model parameters Yₑₛₜ for the associated actuator-measurement pair. This can be expressed as Yₑₛₜ=f(X, θ). The machine specifications X are known a priori without step testing, and the regression parameters θ are determined by the type of regression model used. As an example, in the case of a linear regression, Y=AX+B, where θ=[A,B]. The process model parameters Y could include a gain value defining a gain from an actuator (MV) to a measured variable (CV) and a cutoff wavelength value defining a shortest controllable wavelength. An alternative representation could use parameters of divergence, attenuation, and response width as the process model parameters Y. Any other suitable process model parameters could be used. The statistical regression can be used to determine, for instance, how process model parameters tend to vary with different machine specifications like actuator type, actuator spacing, measurement type, machine dimensions, web grade, and machine peed. The machine specifications X for a specific web manufacturing or processing system can be obtained (such as from a user via the tool 130) and plugged into the statistical model f with its regression parameters θ in order to obtain the estimated process model parameters Yₑₛₜ for the associated actuator type and sensor measurement or inferred property type in that web manufacturing or processing system.

Any suitable types of data could be used to identify the statistical model(s). In some embodiments, the data includes the model parameters Y for previously-existing process models and/or data sets associated with step testing or other operations of the web systems. The data sets could include web measurements from sensors, such as basis weight, caliper, CD stiffness, MD stiffness, coating weight, coating type, conditioned weight, dry weight, gloss type, moisture, and squareness ratio. Also, the data could include information about the actuators in a system. For example, information associated with any of the actuators described above with respect to the system 100 could be used. Information associated with any other or additional type(s) of actuators associated with a paper machine or other web manufacturing or processing system could also be used.

Prior to the regression analysis, various operations could occur to prepare the process models, data sets, or other information for analysis. For example, data can be “cleaned” prior to identification of the statistical model(s), such as by removing “not a number” (NaN) and implausible data. Also, data for differing units can be consolidated, and data for sensors and actuators can be grouped and consolidated. In addition, actual process models used by web manufacturing and processing systems can be transformed into a format suitable for regression, such as a unique and not over-parameterized format.

Although FIG. 2 illustrates one example of a system 200 for step test-free web machine modeling using statistical information about multiple web manufacturing or processing systems, various changes may be made to FIG. 2. For example, the system 200 could include any number of sites, web systems, controllers, gateways, databases, data analytics, servers, and network-based environments. Also, the makeup and arrangement of the system 200 in FIG. 2 is for illustration only. Components could be added, omitted, combined, or placed in any other suitable configuration according to particular needs. Further, particular functions have been described as being performed by particular components of the system 200. This is for illustration only. In general, systems such as this are highly configurable and can be configured in any suitable manner according to particular needs. In addition, FIG. 2 illustrates an example environment in which the functions of the data analytics 212 can be used. This functionality can be used in any other suitable device or system.

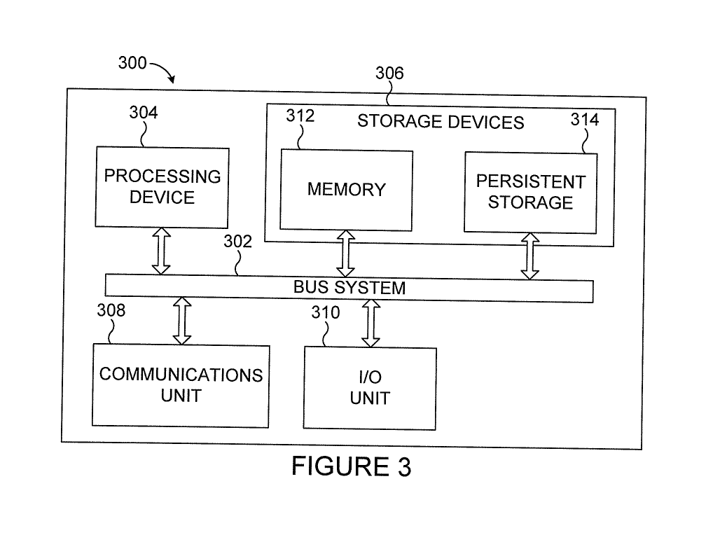

FIG. 3 illustrates an example device 300 supporting step test-free web machine modeling using statistical information about multiple web manufacturing or processing systems according to this disclosure. The device 300 could, for example, represent the operator console 132 used to provide the tool 130 or the server 214 or computing device within the network-based environment 216 used to provide the data analytics 212. Note, however, that the tool 130 or data analytics 212 could be used with any other suitable device(s).

As shown in FIG. 3, the device 300 includes a bus system 302, which supports communication between at least one processing device 304, at least one storage device 306, at least one communications unit 308, and at least one input/output (I/O) unit 310. The processing device 304 executes instructions that may be loaded into a memory 312. The processing device 304 may include any suitable number(s) and type(s) of processors or other devices in any suitable arrangement. Example types of processing devices 304 include microprocessors, microcontrollers, digital signal processors, field programmable gate arrays, application specific integrated circuits, and discrete circuitry.

The memory 312 and a persistent storage 314 are examples of storage devices 306, which represent any structure(s) capable of storing and facilitating retrieval of information (such as data, program code, and/or other suitable information on a temporary or permanent basis). The memory 312 may represent a random access memory or any other suitable volatile or non-volatile storage device(s). The persistent storage 314 may contain one or more components or devices supporting longer-term storage of data, such as a read only memory, hard drive, Flash memory, or optical disc.

The communications unit 308 supports communications with other systems or devices. For example, the communications unit 308 could include a network interface card that facilitates communications over at least one Ethernet network. The communications unit 308 could also include a wireless transceiver facilitating communications over at least one wireless network. The communications unit 308 may support communications through any suitable physical or wireless communication link(s).

The I/O unit 310 allows for input and output of data. For example, the I/O unit 310 may provide a connection for user input through a keyboard, mouse, keypad, touchscreen, or other suitable input device. The I/O unit 310 may also send output to a display, printer, or other suitable output device.

Although FIG. 3 illustrates one example of a device 300 supporting step test-free web machine modeling using statistical information about multiple web manufacturing or processing systems, various changes may be made to FIG. 3. For example, various components in FIG. 3 could be combined, further subdivided, rearranged, or omitted and additional components could be added according to particular needs. Also, computing devices can come in a wide variety of configurations, and FIG. 3 does not limit this disclosure to any particular configuration of computing device.

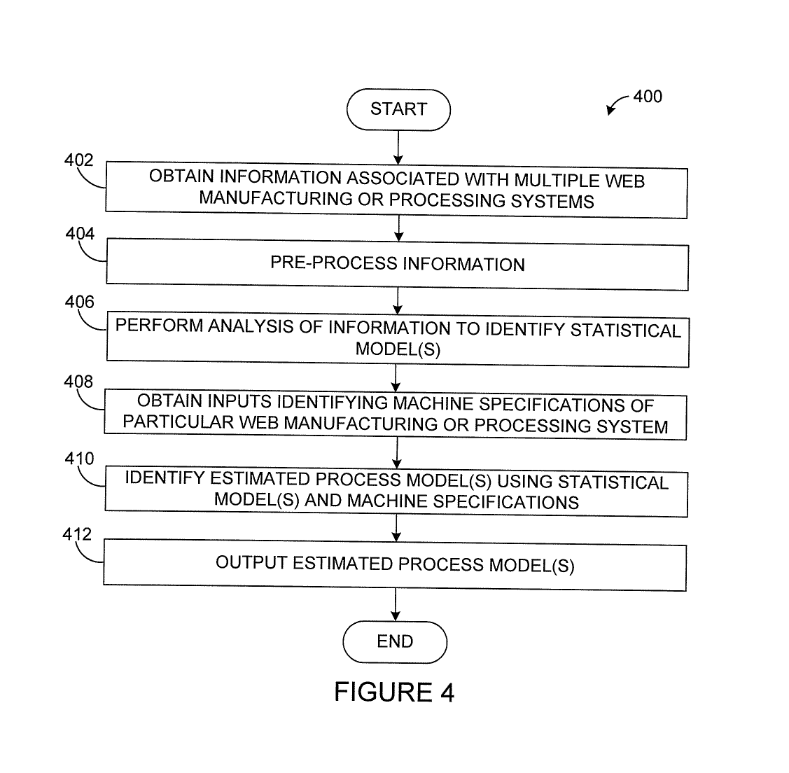

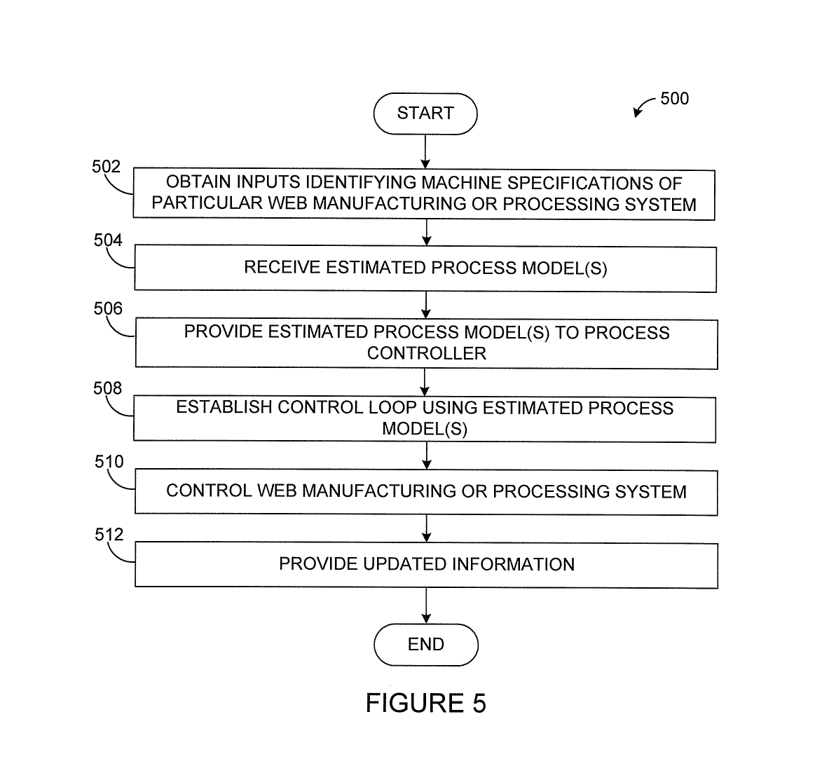

FIGS. 4 and 5 illustrate example methods for step test-free machine modeling using statistical information about multiple web manufacturing or processing systems according to this disclosure. In particular, FIG. 4 illustrates an example method 400 that could be performed by the server 214 or network-based environment 216, and FIG. 5 illustrates an example method 500 that could be performed by the tool 130. However, each method could be used with any other suitable device and in any other suitable system.

As shown in FIG. 4, information associated with multiple web manufacturing and processing systems is obtained at step 402. This could include, for example, the server 214 or network-based environment 216 obtaining information about web manufacturing and processing systems from the database 210. The information could include process models (such as model parameters) used by the web manufacturing and processing systems. The information could also include data sets associated with the web manufacturing and processing systems, such as sensor measurement or inferred property data or actuator control signal data. The information further includes information about the physical designs of those web manufacturing and processing systems, such as actuator types, actuator spacings, measurement types, dimensions, web grades, and machine speeds.

The information is pre-processed at step 404. This could include, for example, the processing device 304 of the server 214 or network-based environment 216 pre-processing the information to clean and group/consolidate the data. This could also include the processing device 304 of the server 214 or network-based environment 216 transforming process models into a suitable format for analysis.

An analysis of the information is performed at step 406. This could include, for example, the processing device 304 of the server 214 or network-based environment 216 performing a regression analysis of the collected and pre-processed information for each of one or more actuator-measurement pairs. One goal of the analysis is to identify how different machine specifications affect the parameters of process models used by controllers in the web manufacturing or processing systems. The results of the analysis include one or more statistical models that capture how the different machine specifications affect the parameters of the process models.

At this point, the statistical model(s) could be used in any suitable manner. For example, inputs identifying one or more machine specifications of a particular web manufacturing or processing system can be obtained at step 408. This could include, for example, the server 214 or network-based environment 216 receiving the one or more machine specifications from a user, such as via the tool 130. The statistical model(s) and the one or more machine specifications can be used to determine one or more estimated process models for the particular web manufacturing or processing system at step 410. This could include, for example, the processing device 304 of the server 214 or network-based environment 216 plugging the received machine specifications X (along with regression parameters θ) into one or more statistical models f, each of which generates estimated process model parameters Yₑₛₜ. The estimated process model(s) can be output at step 412. This could include, for example, the processing device 304 of the server 214 or network-based environment 216 providing the estimated process model parameters Yₑₛₜ to an operator console 132 or process controller 104, 206.

As shown in FIG. 5, inputs identifying one or more machine specifications of a particular web manufacturing or processing system are obtained at step 502. This could include, for example, the operator console 132 executing the tool 130 and receiving one or more machine specifications from a user. The machine specifications can include actuator type, actuator spacing, measurement type, machine dimensions, web grade, and machine speed. One or more estimated process models are received at step 504. This could include, for example, the operator console 132 providing the one or more machine specifications to the server 214 or network-based environment 216 and receiving one or more estimated process models (such as estimated process model parameters Yₑₛₜ) from the server 214 or network-based environment 216. The estimated process model or models are based on the one or more machine specifications.

The estimated process model(s) can be provided to one or more process controllers at step 506. This could include, for example, the operator console 132 providing the estimated process model parameters Yₑₛₜ for each estimated model to the process controller 104, 206 using a graphical user interface or other interface of the process controller 104, 206. At least one control loop is established in the process controller at step 508, and the web manufacturing or processing system is controlled at step 510. This could include, for example, a user establishing one or more control loops operating in closed-loop mode using the estimated process model(s). As part of the control loops, the process controller 104, 206 can receive sensor measurements and use the estimated process model(s) to generate actuator control signals, which alter the web manufacturing or processing system.

Optionally, updated information about the particular web manufacturing or processing system could be provided to a remote location at step 512. This could include, for example, the operator console 132 providing updated machine specifications X and process model parameters Y to the server 214 or network-based environment 216 whenever a step test of the particular web manufacturing or processing system is carried out. The server 214 or network-based environment 216 could then store this information in the database 210, helping to improve future computations by the server 214 or network-based environment 216.

Although FIGS. 4 and 5 illustrate examples of methods for step test-free machine modeling using statistical information about multiple web manufacturing or processing systems, various changes may be made to FIGS. 4 and 5. For example, while each figure shows as a series of steps, various steps in each figure could overlap, occur in parallel, occur in a different order, or occur any number of times. As a particular example, steps 402-406 at the server 214 or network-based environment 216 could occur continuously or intermittently, such as at specified intervals or in response to a triggering event (such as the uploading of new data). This allows the server 214 or network-based environment 216 to process new data and update the regression with all available data. Also, various steps in the figures can be performed by the same device or by different devices other than as described above. For instance, the server 214 or network-based environment 216 could operate to identify the statistical model(s), and the statistical model(s) could be provided to the operator console 132 or other device so that the operator console 132 or other device can identify the estimated process model(s). In general, any division between the server 214 or network-based environment 216 and the operator console 132 could be used, or the entire process could be performed using only the server 214 or network-based environment 216 or only the operator console 132.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Also, none of the claims is intended to invoke 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining at least one statistical model identified using data associated with multiple web manufacturing or processing systems, the data including process models used to control the multiple web manufacturing or processing systems;
obtaining one or more machine specifications of a particular web manufacturing or processing system; and
generating at least one estimated process model for the particular web manufacturing or processing system using the at least one statistical model and the one or more machine specifications.

2. The method of claim 1, wherein the at least one estimated process model is generated without step testing of the particular web manufacturing or processing system.

3. The method of claim 1, further comprising:
generating the at least one statistical model using the data associated with the multiple web manufacturing or processing systems.

4. The method of claim 3, wherein generating the at least one statistical model comprises performing a statistical regression for each of multiple actuator-measurement pairs, each actuator-measurement pair associated with a particular type of actuator in the multiple web manufacturing or processing systems and a particular type of sensor measurement or inferred property in the multiple web manufacturing or processing systems.

5. The method of claim 4, wherein each statistical regression generates a statistical model f, which associates machine specifications X and regression parameters θ with estimated process model parameters Yₑₛₜ such that Yₑₛₜ=f(X, θ).

6. The method of claim 1, wherein the data further comprises at least one of:
sensor measurements or inferred properties captured or determined by the multiple web manufacturing or processing systems;
actuator control signals generated by the multiple web manufacturing or processing systems; and
data associated with step testing of the multiple web manufacturing or processing systems.

7. The method of claim 1, wherein the one or more machine specifications of the particular web manufacturing or processing system comprise at least one of:
a type of actuator in the particular web manufacturing or processing system;
a spacing of actuators in the particular web manufacturing or processing system;
a type of sensor measurement captured by the particular web manufacturing or processing system;
a dimension of the particular web manufacturing or processing system;
a grade of web being manufactured or processed by the particular web manufacturing or processing system; and
a machine speed of the particular web manufacturing or processing system.

8. The method of claim 1, wherein:
obtaining the one or more machine specifications comprises obtaining the one or more machine specifications from an operator console; and
the method further comprises outputting the at least one estimated process model to the operator console.

9. The method of claim 1, wherein:
obtaining the at least one statistical model comprises obtaining the at least one statistical model at an operator console; and
the method further comprises outputting the at least one estimated process model from the operator console to at least one process controller.

10. The method of claim 1, wherein gain scheduling is built into the at least one estimated process model due to each process model being a function of the one or more machine specifications.

11. An apparatus comprising:
at least one memory configured to store at least one statistical model identified using data associated with multiple web manufacturing or processing systems, the data including process models used to control the multiple web manufacturing or processing systems; and
at least one processing device configured to:
obtain one or more machine specifications of a particular web manufacturing or processing system; and
generate at least one estimated process model for the particular web manufacturing or processing system using the at least one statistical model and the one or more machine specifications.

12. The apparatus of claim 11, wherein the at least one processing device is configured to generate the at least one estimated process model without step testing of the particular web manufacturing or processing system.

13. The apparatus of claim 11, wherein the at least one processing device is further configured to generate the at least one statistical model using the data associated with the multiple web manufacturing or processing systems.

14. The apparatus of claim 13, wherein the at least one processing device is configured to generate the at least one statistical model by performing a statistical regression for each of multiple actuator-measurement pairs, each actuator-measurement pair associated with a particular type of actuator in the multiple web manufacturing or processing systems and a particular type of sensor measurement or inferred property in the multiple web manufacturing or processing systems.

15. The apparatus of claim 11, wherein the data further comprises at least one of:
sensor measurements or inferred properties captured or determined by the multiple web manufacturing or processing systems;
actuator control signals generated by the multiple web manufacturing or processing systems; and
data associated with step testing of the multiple web manufacturing or processing systems.

16. The apparatus of claim 11, wherein the one or more machine specifications of the particular web manufacturing or processing system comprise at least one of:
a type of actuator in the particular web manufacturing or processing system;
a spacing of actuators in the particular web manufacturing or processing system;
a type of sensor measurement captured by the particular web manufacturing or processing system;
a dimension of the particular web manufacturing or processing system;
a grade of web being manufactured or processed by the particular web manufacturing or processing system; and
a machine speed of the particular web manufacturing or processing system.

17. The apparatus of claim 11, wherein the apparatus comprises a computing device comprising at least one interface configured to:
receive the one or more machine specifications from a remote operator console; and
communicate the at least one estimated process model to the operator console.

18. The apparatus of claim 11, wherein the apparatus comprises a computing device comprising at least one interface configured to:
obtain the at least one statistical model from a remote computing device; and
output the at least one estimated process model to at least one process controller.

19. A non-transitory computer readable medium containing instructions that when executed cause at least one processing device to:
obtain at least one statistical model identified using data associated with multiple web manufacturing or processing systems, the data including process models used to control the multiple web manufacturing or processing systems;
obtain one or more machine specifications of a particular web manufacturing or processing system; and
generate at least one estimated process model for the particular web manufacturing or processing system using the at least one statistical model and the one or more machine specifications.

20. The non-transitory computer readable medium of claim 19, wherein the non-transitory computer readable medium contains:
instructions that when executed cause the at least one processing device to generate the at least one estimated process model without step testing of the particular web manufacturing or processing system.

21. The non-transitory computer readable medium of claim 19, wherein the non-transitory computer readable medium further contains instructions that when executed cause the at least one processing device to:
generate the at least one statistical model using the data associated with the multiple web manufacturing or processing systems.

22. A method comprising:
obtaining data associated with multiple web manufacturing or processing systems, the data including machine specifications of the multiple web manufacturing or processing systems and process models used to control the multiple web manufacturing or processing systems;
generating at least one statistical model using the data; and
providing the at least one statistical model in order to generate at least one estimated process model for a particular web manufacturing or processing system using the at least one statistical model and one or more machine specifications of the particular web manufacturing or processing system.
